(19) United States
(12) Patent Application Publication
(10) Pub. No.: US 2010/0089890 A1
(43) Pub. Date: Apr. 15, 2010

(54) Wire Feeder

(76) Inventor: Glenn B. Manning, Foley, AL (US)

Correspondence Address: WARNER J DELAUNE JR;Baker Donelson Bearman Caldwell & Berkowitz, Chase North Tower, 450 Laurel Street, 20th Floor, Baton Rouge, LA, 70801, US

(21) Appl. No.: 12/574,253

(22) Filed: Oct. 6, 2009

Related U.S. Application Data
(60) Provisional application No. 61/103,991, filed on Oct. 9, 2008.

(51) Int. Cl. B23K 9/12

(52) U.S. Cl. 219/137.2

(57) ABSTRACT

A wire feeder for laser welding is provided, comprising a body having a first end and a second end, and a longitudinal passageway extending from the second end to the first end, wherein the passageway is sized to permit passage of a wire therethrough. A wire feeding tube is connected to the first end of the body and in communication with the passageway, and a wire holder is connected to the second end of the body, wherein the wire holder contains a supply of wire. A feeding device is mounted on the body and in communication with the passageway, wherein the feeding device is adapted to urge the wire through the wire feeding tube. The wire feeder may be used for a variety of intricate welding operations, but is particularly suited for laser welding in the jewelry field.

### CROSS-REFERENCE TO RELATED APPLICATIONS

This nonprovisional patent application claims priority under 35 U.S.C. 517 119 to U.S. Provisional Application Ser. No. 61/103,991, filed on Oct. 9, 2008.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to devices used to store and feed a wire for use in laser welding, as well as to methods of manufacturing such devices.

2. Description of Related Art

In the field of laser welding, the welding technique requires a small spot size, resulting in small heat-affected zones and high heating and cooling rates. Consequently, there is a need for precise positioning of the welding wire very close to the point where the laser strikes.

### SUMMARY OF THE INVENTION

A wire feeder for laser welding is provided, comprising a body having a first end and a second end, and a longitudinal passageway extending from the second end to the first end, wherein the passageway is sized to permit passage of a wire therethrough; a wire feeding tube connected to the first end of the body and in communication with the passageway; a wire holder connected to the second end of the body, wherein the wire holder contains a supply of wire; and a feeding device mounted on the body and in communication with the passageway, wherein the feeding device is adapted to urge the wire through the wire feeding tube.

Optionally, the feeding device may be operable by a motor, or it may comprise a manually operated roller, wherein a portion of the wire resides between the roller and an opposing member resiliently biased against the roller. The roller may include a textured surface sufficient to grip the portion of the wire when the wire is urged through the feeding tube.

In a preferred embodiment, the body includes an internal cavity having a conically tapered portion sufficient to guide the wire from the holder into the passageway without compromising the structural integrity of the wire. It is also preferred that the passageway is immediately adjacent to the feeding device as the wire is urged toward the feeding tube by the feeding device.

The wire stored within the wire holder is preferably between 28 gauge and 36 gauge wire, which is typically used in laser welding applications. The body is optionally color-coded to a specific wire type, and the wire holder includes indicia to identify the wire contained within the wire holder. Preferably, the wire holder is constructed from a material sufficiently transparent to enable a user to ascertain the remaining supply of wire within the wire holder.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 shows a top view of a wire feeder in accordance with one embodiment of the present invention.

FIG. 2 shows a perspective exploded view of the embodiment of FIG. 1.

FIG. 3 shows another top view of the embodiment of FIG. 1.

FIG. 4 shows a cross-sectional view of the embodiment of FIG. 1.

FIG. 5 shows a perspective view of the embodiment of FIG. 1.

FIG. 6 shows an alternative embodiment of the invention having a replaceable cartridge.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

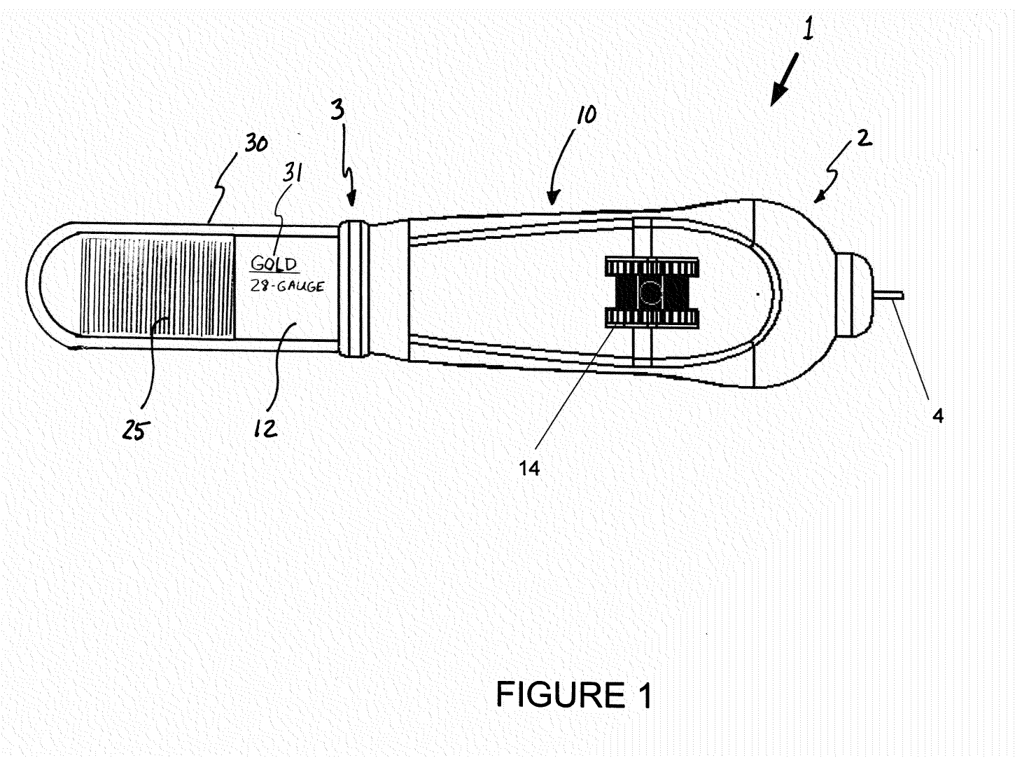

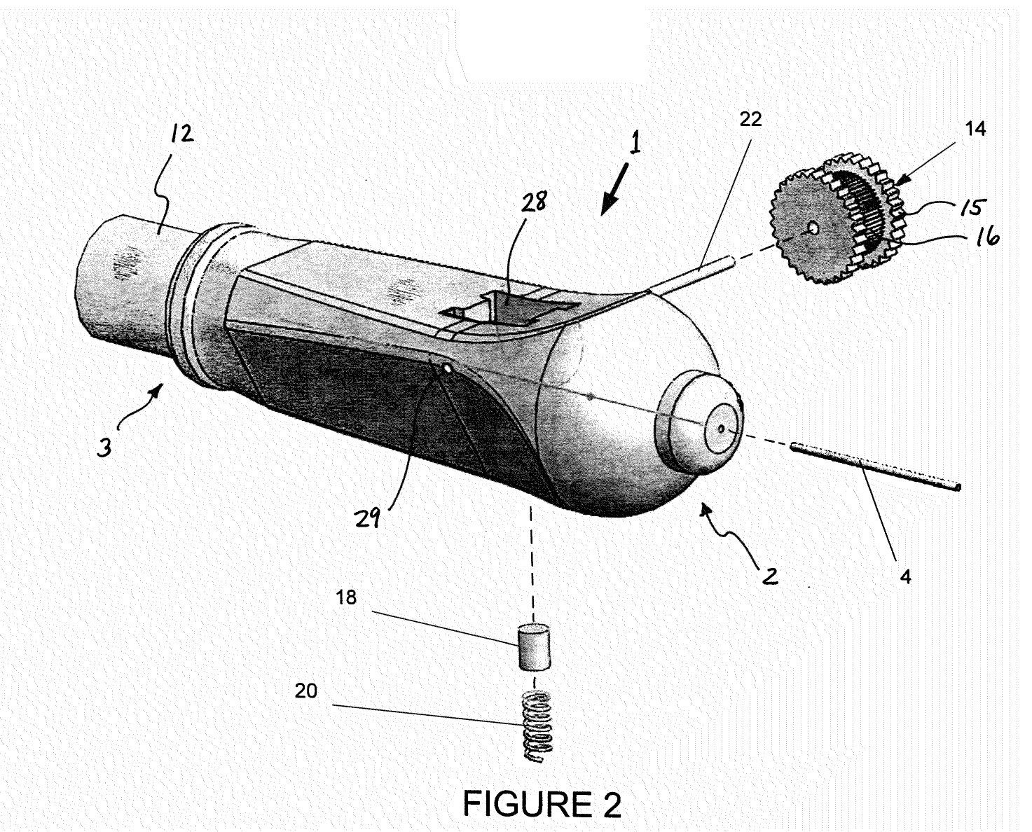

FIGS. 1 and 2 show one exemplary embodiment of a wire feeder 1 used for precise positioning of a welding wire. The welding wire may be of any suitable size, including but not necessarily limited to small gauge wire. The wire feeder 1 may be used for laser welding as well as other types of welding requiring the use of fine wire, typically 28 gauge to 36 gauge wire, such as in jewelry manufacturing and repair.

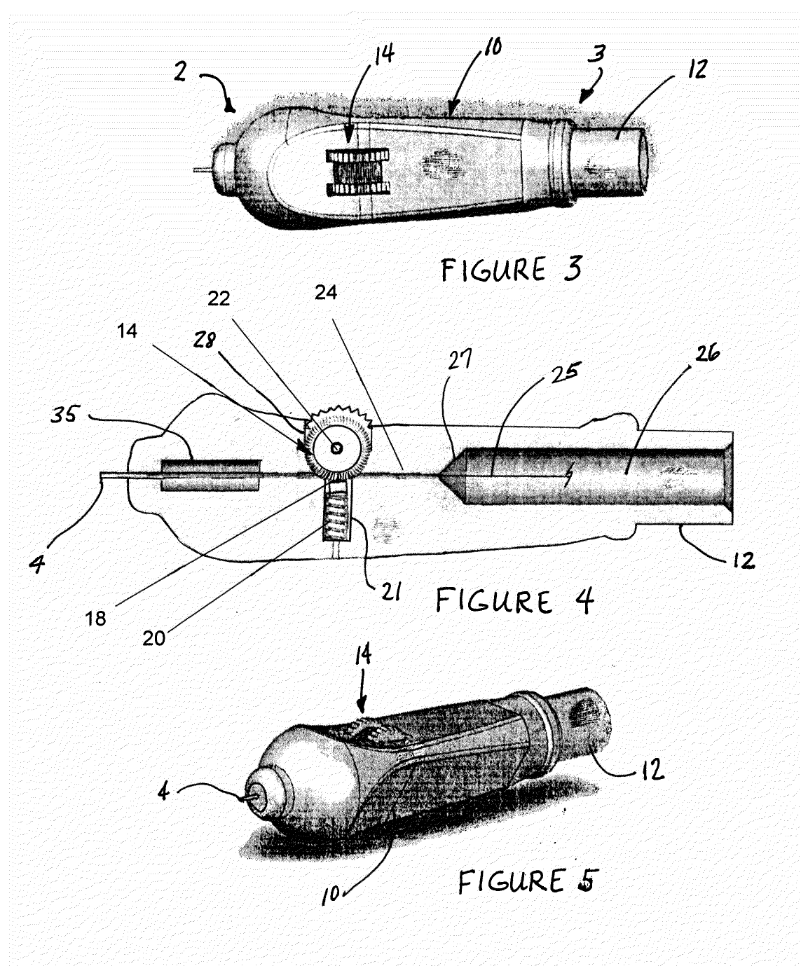

In the exemplary embodiment as shown in FIGS. 1-5, the wire feeder 1 comprises a body 10 having a first end 2 and a second end 3 with a wire holder mount 12 at the second end 3. The welding wire 25 may be stored or coiled inside a wire holder 30, which may be attached to, inserted into, or mounted over the wire holder mount 12 as shown in FIG. 1. The wire holder 30 is illustrated in FIG. 1 only, and is not shown in the remaining figures for clarity. The wire holder 30 may be permanently attached, or removably attached (such as by screwing, or by the use of clips, snaps, or similar fastening techniques) from the body 10 so as to allow for replacement of the welding wire 25 as needed. As seen in FIG. 4, an internal cavity 26 is formed within the body 10 and extends from the second end 3 into the interior of the body 10. The internal cavity 26 ends in a conically tapered portion 27 which is sized and shaped to guide the wire 25 into the passageway 24 without compromising the structural integrity of the wire 25. In other words, the wire 25 should glide easily across the tapered portion 27 and into the passageway 24 without kinking or breaking the wire 25.

In one exemplary embodiment, the wire holder 30 is in the form of a tube formed from plastic or other suitable material, and mounted over the wire holder mount 12. Preferably, the wire holder 30 is constructed from a material sufficiently transparent to enable a user to visibly ascertain the remaining supply of wire 25 within the wire holder 30. Also, it is preferred that the wire holder 30 include some form of indicia 31, such as lettering or numbering, to identify the specific type of wire 25 contained within the wire holder 30, e.g. the size of the wire 25, the amount of wire 25, and the type of metal. During assembly, welding wire 25 is coiled separately and placed inside the wire holder 30. In one embodiment, the body 10 is approximately 2 to 4 inches in length, and the wire holder 30 is approximately 2 to 4 inches in length.

Preferably, the welding wire 25 is fed through a longitudinal passageway 24 in the body 10 by turning a feed roller 14 installed into a recess 28 in the body 10. The recess 28 communicates with the passageway 24, such that rotation of the feed roller 14 draws the wire 25 from the passageway 24 and urges the wire 25 through the first end 2 of the body 10. The feed roller 14 is rotatably mounted on the body 10 by an axle 22 inserted through an axle mounting hole 29 formed into the body 10, best shown in FIG. 2. The feed roller 14 preferably includes at least one knurled outer wheel 15 which can be positively turned by the user's finger, and a smaller inner wheel 16 having serrations or a textured surface to firmly grip the wire 25.

When the wire 25 is contacted by the inner serrated wheel 16 of the feed roller 14, it is important that the wire 25 is adequately supported underneath to prevent the wire 25 from becoming kinked or otherwise undesirably bent inside the body 10, and to enable the inner wheel 16 to firmly grip the wire 25. Therefore, in a preferred embodiment best shown in FIGS. 2 and 4, a plunger or rod 18 is resiliently biased by a spring 20 against the inner wheel 16 of the feed roller 14, such that the wire 25 slides against the plunger 18 as it is urged through the passageway 24. During assembly of the device 1, the spring 20 is inserted into a spring retaining hole 21 formed into the body 10, followed by the plunger 18. The feed roller 14 and axle 22 are then installed as described previously herein.

A wire feeding tube or needle 4 is connected to the first end 2 of the body 10 and is in communication with the passageway 24. The wire feeding tube 4 is mounted to the first end 2 by press fitting, adhesive bonding, or any other suitable method that does not obstruct the wire 25 from passing easily from passageway 24 into the wire feeding tube 4. Optionally, a rubber retaining sleeve 35 may also be employed within a suitable void formed into the body 10. The wire feeding tube 4 extends from the first end 2 and is employed during welding to guide the wire 25 for precise positioning. The wire feeding tube 4 may be of any suitable length and material, although it would typically be constructed of steel and extend about 5-20 millimeters from the front end 2.

Because of the challenges working with fine wire, especially in the range of 28-36 gauge wire, it is easy for such wire to become kinked or bent inside the device 1, especially as the wire 25 leaves the feed roller 14 and re-enters the passageway 24. Therefore, to minimize such problems, it is desirable for the passageway 24 to be immediately adjacent to the feed roller 14 as the wire 25 is urged toward the first end 2.

In one embodiment, the feed roller 14 may alternatively be turned by a small electric motor placed inside the body 10 to provide motive force at the press of a button or movement of a switch. In one embodiment, the feed roller 14 may be totally enclosed in the body 10 with the motor and power source (such as a battery), with only a button or switch on the surface.

The body 10 may be of any size and shape suitable for operation by a welder. Specifically, it may be elongated with a three-sided cross-section in part, as shown, or be a cylinder or oval. The feed roller 14 may be on the top, bottom, or side of the body 10 when in use, and multiple feed rollers may be used. The body 10 may be solid, or hollow in whole or in part to reduce weight. It may be made of any suitable material, but preferably of plastic. Conveniently, the body 10 may be constructed in different colors, such that color-coded bodies 10 are used to indicate different types of wire 25. In one embodiment, the device may be provided as a complete, disposable unit, with wire 25 pre-loaded in a permanently attached wire holder 30.

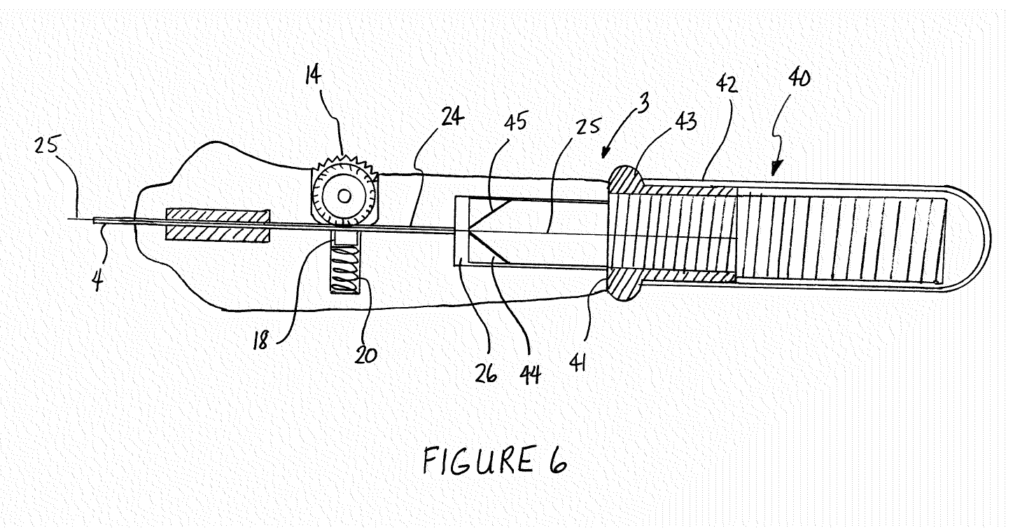

Finally, with reference to FIG. 6, an alternative embodiment is depicted wherein the device 1 includes a replaceable cartridge 40. The cartridge 40 is loaded with a coiled wire 25 as described above, and comprises a transparent tube 42 mounted onto a cartridge base 43. A cylindrical guide portion 44 extends from the base 43 and includes a conically tapered portion 45 to guide the wire 25 into the cavity 26 of the body 10. When a new cartridge 40 is desired, a loaded cartridge 40 is inserted into the body 10, such that the guide portion 44 is snugly received within the cavity 26 of the body 10. When the cartridge 40 is empty, a new cartridge 40 is simply installed as a replacement, thus keeping the body 10 as a reusable device.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

1. A wire feeder, comprising:
(a) a body having a first end and a second end, and a longitudinal passageway extending from the second end to the first end, wherein the passageway is sized to permit passage of a wire therethrough;
(b) a wire feeding tube connected to the first end of the body and in communication with the passageway;
(c) a wire holder connected to the second end of the body, wherein the wire holder contains a supply of wire; and
(d) a feeding device mounted on the body and in communication with the passageway, wherein the feeding device is adapted to urge the wire through the wire feeding tube.

2. The device of claim 1, wherein the feeding device comprises a manually operated roller, wherein a portion of the wire resides between the roller and an opposing member resiliently biased against the roller.

3. The device of claim 2, wherein the roller includes a textured surface sufficient to grip the portion of the wire when the wire is urged through the feeding tube.

4. The device of claim 1, wherein the feeding device is operable by a motor.

5. The device of claim 1, wherein the wire holder is a removable cartridge attachable to the body, and wherein the cartridge includes a conically tapered portion sufficient to guide the wire into the passageway without compromising the structural integrity of the wire.

6. The device of claim 1, wherein the body includes an internal cavity having a conically tapered portion sufficient to guide the wire from the wire holder into the passageway without compromising the structural integrity of the wire.

7. The device of claim 1, wherein the passageway is immediately adjacent to the feeding device as the wire is urged toward the feeding tube by the feeding device.

8. The device of claim 1, wherein the wire is between 28 gauge and 36 gauge wire.

9. The device of claim 1, wherein the body is color-coded to a specific wire type.

10. The device of claim 1, wherein the wire holder includes indicia to identify the wire contained within the wire holder.

11. The device of claim 1, wherein the wire holder is constructed from a material sufficiently transparent to enable a user to ascertain the remaining supply of wire within the wire holder.
